(19) United States
(12) Patent Application Publication
(10) Pub. No.: US 2011/0223258 A1
(43) Pub. Date: Sep. 15, 2011

(54) Ferric Phosphate Based Composition, the Preparation and Use Thereof

(75) Inventor: Gennadi Nikolaev, Tallinn (EE)

(73) Assignee: Irina Nikolajeva, Tallinn (EE)

(21) Appl. No.: 13/060,027

(22) PCT Filed: Aug. 19, 2009
(86) PCT No.: PCT/EE2009/000012

§ 371 Date: May 5, 2011

(30) Foreign Application Priority Data
Aug. 22, 2008 (EE) P200800055

(51) Int. Cl. A01N 59/26; C09K 21/04; C09K 3/00; A01P 1/00

(52) U.S. Cl. 424/604; 252/607; 252/387; 252/182.33

(57) ABSTRACT

The invention deals with an ferric phosphate based composition, in order to obtain which 100 mass fractions of orthophosphoric acid, 10-20 mass fractions of iron(III) oxide, 5-10 mass fractions of powdery aluminium oxide and 100 mass fractions of water are mixed, whereas the reaction takes place within a temperature range of 60-70° C. and at least one nanopowder from among silver, copper or flint is added to the mixture in the amount of 0.5 mass fractions, The ferric phosphate based compositions can be used for the bio- and fire protection of timber, as an antibacterial disinfectant, as well as a rust converter for the rust-inhibiting of metals.

### TECHNICAL FIELD

The invention deals with a phosphate based composition, which can be used for the bio- and fire protection of timber, as an antibacterial disinfectant, as well as a rust converter for the corrosion protection of metals.

### TECHNICAL LEVEL

A phosphorus compound and the use thereof are known (U.S. Pat. No. 6,350,474 B1, A01N 59/00, David Dzneladze et al., 2002), whereas the composition of the phosphorus compound is:

| | | |
|---|---|---|
| orthophosphoric acid | 100 | mass fractions, |
| iron oxide | 20-41 | mass fractions, |
| aluminium powder | 0.5-2.5 | mass fractions, |
| water | 30-70 | mass fractions. |

To obtain the compound, water and iron oxide and aluminium powder are mixed with orthophosphoric acid, whereby an exothermic reaction takes place. The heat released is sufficient to dissolve the iron oxide and aluminium powder.

The phosphoric compound obtained is absolutely harmless to nature. It can be used as an impregnating agent to increase the fire resistance of materials, as well as to increase the strength and heat resistance of concrete and ceramics, as a preservative, as a rust-inhibiting agent.

A disadvantage of the compound is its relatively low stability and low wetting capacity, which impede a broad use of the compound.

A phosphoric compound is also known (utility model EE 00444 U1, A01N 59/26, Gennadi Nikolaev, 2004), which is distinguished by the fact that, in order to increase its stability and wetting capacity, amounts of orthophosphoric acid, iron oxide, aluminium powder and water with ratios known from U.S. Pat. No. 6,350,474 B1 are mixed and 0.05-0.2 mass fractions of either ethyl alcohol or glycerine are added to the mixture.

When using the compound obtained as a surface preserving-coating material, a disadvantage is the low fire resistance of materials covered with the compound, for example timber, paper, textile and metal surfaces, and inadequate protection against rotting and humidity.

Also utility model EE 00549 U1, C09D 5/18, Gennadi Nikolaev et al., 2005, is known, which deals with a surface preserving-coating material with the following composition:

| | | |
|---|---|---|
| orthophosphoric acid | 60-80 | mass fractions, |
| iron oxide | 50-60 | mass fractions, |
| aluminium powder | 5-10 | mass fractions, |
| water | 40-60 | mass fractions, |
| ammonium nitrate | 7-10 | mass fractions, |
| copper sulphate | 7-10 | mass fractions, and |

| | |
|---|---|
| colouring pigments | Fe₂O₃, TiO₂, MnO₂ |

Even though covering with a solution of a phosphoric compound like that increases the fire resistance of materials and decreases the risks of rotting and humidity, the fire and bio-protection of materials containing cellulose is inadequate and fails, for instance, to meet the requirements of fire resistance class B-s1-d0 of timber constructions, as determined by standards EN 13823:2002 and EN ISO 11925-2.

A known solution closer to this invention can be regarded the aforementioned patent U.S. Pat. No. 6,350,474 B1 by David Dzneladze et al., which deals with an ferric phosphate based composition, which consists of orthophosphoric acid, iron(III) oxide, aluminium powder and water and which is obtained by mixing water, iron oxide and metallic aluminium with orthophosphoric acid.

### SUBJECT MATTER OF THE INVENTION

The task of this invention is to obtain an ferric phosphate based composition, the use of which increases substantially the fire resistance and bio-protection of materials containing cellulose.

The task set is solved in such a manner that in the ferric phosphate based composition, to obtain which 100 mass fractions of orthophosphoric acid is mixed with water, iron oxide and an aluminium source, using powdery Al₂O₃ in the amount of 5-10 mass fractions as the aluminium source, thereby maintaining the reaction temperature within a range of 60-70° C. Due to an exothermic reaction no additional energy source is necessary to dissolve the components. The amount of the iron oxide constitutes 10-20 mass fractions and the amount of the water 100 mass fractions, whereby the composition is distinguished by the fact that at least one nanopowder from among silver, copper or flint in the amount of 0.5 mass fractions is added to the mixture. Due to the proportions of the components according to the invention, the relative percentage of the aluminium oxide increases, which improves the properties of the final concentrate substantially, as a result of which the fire and bio-resistance of materials containing cellulose covered with the said composition increases.

The iron sulphate composition according to the invention forms in the course of the following chemical processes.

Water, powdery iron oxide Fe2O3 and aluminium oxide powder Al2O3, as well as nanopowders of silver, copper and flint are added to orthophosphoric acid while mixing constantly, maintaining the temperature in the reaction zone within a range of 60 to 70° C. The synthesis of ferric phosphate takes place until the dissolution of the metal oxides into a colloidal state, i.e. in the course of the reaction a homogenous liquid with no apparent deposit forms.

The saturation of the liquid with iron, aluminium and other oxides takes place at an exothermic reaction, thereby the technological process requires no introduction of power or thermal energy from outer sources, which reduces the cost price of the composition.

The proportions of the components in mass fractions are as follows:

| | |
|---|---|
| Orthophosphoric acid H₃PO₄ (85%) | 100 |
| Iron oxide Fe₂O₃ | 10-20 |
| Aluminium oxide Al₂O₃ | 5-10 |
| At least one nanopowder from among Ag, Cu, Si | 0.5 |
| Water | 100 |

Preferably the reaction takes place in a temperature range of 60-70° C. and it is controlled by the amounts of the aluminium oxide and nanopowders added.

The reaction product is iron(III) dihydrogen phosphate dihydrate Fe(H₂PO₄)₃×2H₂O in the form of liquid.

One of the distinguishable characteristics of this invention is increasing the amount of aluminium oxide to 10 parts of the overall mass. This constituent is known to act as a catalyst, modifying the speed of chemical and physical processes towards the direction given. The main function of the aluminium oxide in the invention based process is to facilitate the formation of intermediate compounds between the phosphate and iron with higher reactivity in the course of the synthesis, which allows reducing activation energy and facilitates the formation of the compounds with the given structure. In this case it increases the speed of the synthesis reaction and the preparation time of the composition reduces from 4 hours to 2 hours. The increased amount of the aluminium oxide in the composition reduces such an important indicator as the acidity of the finished mixture, with pH value changing from 0.2 to 1. In addition several properties of the timber improve as a result of the aluminium oxide. Research by the Estonian Central Laboratory of Microbiology and other labs has shown that adding aluminium oxide to a composition increases its antiseptic, disinfecting and fungicide properties and increases the fire resistance of materials covered with the compound and protection from biodegradation.

Another distinguishable characteristic of the invention is adding nanopowdery components, such as Ag, Cu and flint, as a result of which the bactericide properties of the composition and the strength of the layer applied increase.

When preparing the composition, preferably 85% orthophosphoric acid is used, which is industrially treated and used extensively, it can be purchased and used functionally in production.

Another characteristic of the invention is that the iron(III) dihydrogen phosphate dihydrate acts as a modifier by entering into a chemical reaction with the cellulose. At the modification the iron(III) dihydrogen phosphate dihydrate fixes to the timber surface and forms a protecting surface cover.

According to the invention, the composition can be used as a fire protective agent of timber and other materials containing cellulose.

According to the invention, the composition can be used for the bio-protection of timber against decay and rotting.

According to the invention, the composition can be used as a disinfecting antibacterial agent.

According to the invention, the composition can be used as a rust converter and a protecting agent against the corrosion of metals.

### EXAMPLE OF PRACTICAL PERFORMANCE

100 mass fractions of 85% orthophosphoric acid is poured into a reactor, then 100 mass fractions of water, 10-20 mass fractions of comminuted iron(III) oxide, 5-10 mass fractions of powdery aluminium oxide and nanopowders of silver, copper and flint comminuted to particles 50 to 100 nm in the amount of 0.5 mass fractions are added in the presence of constant mixing. An exothermic reaction takes place, in the course of which the neutralisation of excess acidity and the dissolution of the metal oxides takes place. The heat released at the exothermic reaction is sufficient to dissolve the iron oxide and aluminium powder. The reaction temperature is controlled by the amount of the aluminium oxide added and it is maintained within a range of 60 to 70° C.

As a result of the synthesis, a colloidal solution of the orthophosphates is obtained from the nano-iron, -aluminium and silver, copper, silicon metals, which comprise a composition of iron aluminium phosphate Fe(H₂PO₄)₃ and Al(H₂PO₄)₃ with the particle sizes of the metals from 50 to 100 nm.

The following chemical reaction takes place:

6H₃PO₄+Fe₂O₃+H₂O→catalyst→2Fe(H₂PO₄)₃×2H₂O.

At the reaction of the iron with the orthophosphoric acid a wide array of salts forms, including also iron(III) dihydrogen phosphate—Fe(H₂PO₄)₃. These salts can be regarded as oxide mixtures with a generic formula of Fe(H₂PO₄)₃×2H₂O.

The composition obtained is in the form of a light brown, translucent, viscous liquid, which is handy to be used as a cover layer of materials.

The iron (III) dihydrogen phosphate present in the composition is a modifier of bio- and humidity protection for timber materials, which acts by entering into a chemical reaction with the cellulose. At the modification the iron (III) dihydrogen phosphate fixes on the timber surface.

The ferric phosphate based composition can be used as an impregnating agent to increase the fire resistance of timber and other materials containing cellulose, for the bio-protection of timber against decay and rotting, as a disinfecting antibacterial agent, as well as a rust converter for the rust-inhibiting of metals.

The iron(III) dihydrogen phosphate dihydrate is not carcinogenic, it has no accumulating effect and it causes no local irritation.

In the Mar. 7, 2003 report of the University of Tartu “Properties of Fe(H₂PO₄)₃” (see the annex) information on iron(III) dihydrogen phosphate is given. Iron(III) forms a wide array of salts with phosphoric acid, including also Fe(H₂PO₄)₃. These salts can be regarded as oxide mixtures with a generic formula Fe₂O₃×xP₂O₅×yH₂O, where x and y are various integers. The constitution Fe₂O₃×3P₂O₅×6H₂O corresponds to the substance in the case of such a marking. It has also been proposed that the substance is actually ferriphosphoric acid with the constitution H₆(Fe(PO₄)₃. Of similar compounds also Fe(H₂PO₄)₃×H₂O(Fe₂O₃×3P₂O₅×10H₂O) and FeH₃(PO₄)₂×2,5H₂O(Fe₂O₃×2P₂O₅×8H₂O) have been described. In addition to salts with a specific constitution, which can transfer into one another, owing to the conditions, a number of varied intermediate compounds exist. All in all, in the form of the system Fe₂O₃×xP₂O₅×yH₂O one deals with a very complex system, obtaining individual salts from which is not easy (the liquid phases are viscous, the solid sediments present in them are hygroscopic).

The abovementioned data explain, why there is so little discussion about the substance Fe(H₂PO₄)₃ and why a chemical seller does not offer the substance. The substance is soluble in water, the aqueous solution of the substance being brownish.

Fe(H₂PO₄)₃ decomposes in the solution as a result of hydrolysis. Primarily the following processes take place:

Fe³⁺+H₂O [symbol] Fe(OH)²⁺+H⁺ (1)

Fe(OH)²⁺+H₂O [symbol] Fe(OH)₂⁺+H⁺ (2)

H₂PO₄⁻ [symbol] HPO₄²⁻+H⁺ (3)

Owing to the processes taking place, the solution has a very complex constitution. Obviously, there is a very small number of Fe³⁺ ions in the solution, most of the iron being in the form of Fe(OH)²⁺ and Fe(OH)₂⁺, also obviously as various phosphate complexes. It is also possible that the hydrolysis amounts to iron(III) hydroxide and a suspension of iron(III) hydroxide or complexation and association processes take place in the solution.

The product constitutes a viscous, fluid solution (soluble iron 48-60 g/l, soluble aluminium 24-30 g/l, soluble silver of nanopowders 2-3 g/l, orthophosphoric acid 320-380 g/l), the rheology of which is mostly determined by its water content. It is a light brown colour, has a density of 1.47 g/cm³, its viscosity being 34.3 on the basis of B3-4. The composition obtained dissolves well in water, which allows using it extensively at the treatment of timber with a paint roller, brush, airbrush, as well as under pressure on industrial scales. At the drying of the binding agents protective coatings are formed, which are virtually ablation resistant, condense on the surface of the products as moisture, while the mechanical properties of the treated materials preserve for a long period of time.

Examinations of the ferric phosphate based composition according to the invention showed that it has a wide area of application in the timber industry and building, veterinary medicine, agriculture and forest management, as well as at the production of building materials. The composition has an anticorrosive effect on metals, it works as a bio-protection agent and can be used as a preservative in the case of timber. An increase in the fire resistance of timber owing to the composition observed allows us to claim that it can be used as a antipyretic of timber. The composition according to the invention is ecologically harmless, while with its help it is possible to protect the natural resources of a country (trees, metals, soil, water) against decay and pollution.

The ferric phosphate based product on sale is manufactured in a crystalline form and is used also as a food additive. (Brian Steinwand Biopesticides and Pollution Prevention Division (7511 C), Office of Pesticide Programs Environmental Protection Agency, 1200 Pennsylvania Avenue, NW, Washington, D.C., 20460. Phone: 703-305-7973 (or 308-8712). Fax: 703-308-7026. E-mail: steinwand.brian@epa.gov. The EPA Biopesticides Web site is: http://www.epa.gov/pesticides/biopesticides. Review report for the active substance ferric phosphate finalised in the Standing Committee on Plant Health at its meeting on 29 Jun. 2001 in view of the inclusion of ferric phosphate in Annex I of Directive 91/414/EEC.)

The major difference of the ferric phosphate based composition dealt with herein from similar goods manufactured in the world is that the composition is in the form of liquid, whereas the Chinese and American manufacturers sell ferric phosphate without additives and in a crystalline state. The composition according to the invention is in a colloidal state and its constitution involves a wide array of metals of substantial importance; each one of them has its material importance, while they complement one another. The liquid obtained is handy to preserve and transport, easy to use (dissolving with water is enough). It maintains its properties for up to 5 years, is not hazardous or carcinogenic, it is being used widely. The technical properties are certified with production quality certificates of OÜ Holz Prof. Its manufacturing does not generate hazardous waste or waste gases, is ecologically harmless to both people and animals, whereby the manufacturing of crystalline phosphates in China and the USA are accompanied by major problems related to hazardous waste and waste gases.

The manufacturing process of iron(III) dihydrogen phosphate dihydrate takes less time owing to the acceleration of the chemical reaction, the cost price of the produce is lower owing to a decrease in thermal and electric energy related expenses, no large areas or special training for the employees are required for the production.

At the treatment of timber with the phosphate based composition its modification takes place, i.e. covalent bonds are formed between the components of the timber and the protective composition.

The main components of timber are cellulose, lignin and hemicelluloses (HMT), whereby their content varies on a relatively wide scale, depending on the type, age and habitat of the tree. Thus the cellulose content varies 40-60%, HMT—13-25% in the case of coniferous trees and 25-35% in the case of deciduous trees. The lignin content varies to a smaller extent: 18-25% in the case of deciduous trees and 26-35% in the case of coniferous trees. Additionally, the constitution of HMT and lignin is different in the case of deciduous and coniferous trees, as well as in the case of different layers of the tissues, cells and even cell membrane of the timber within one species.

The ferric phosphate based composition does not obstruct the breathing cycle of timber, does not block or conserve its pores, rather than blocks the enzymes and hinders the activity of microorganisms located on the timber or growing on it (spores of fungi decomposing timber). The composition creates a strong bond with timber, decreasing its porosity.

At modification the chemical fixing of the components of the composition on the surface of timber takes place according to the following scheme:

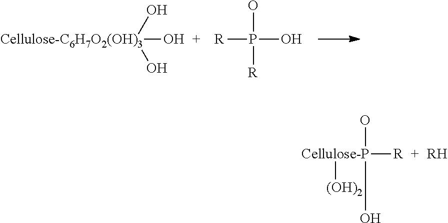

### Cellulose

According to Freidenberg's formula the following functional groups are present in natural lignin: metoxyl, phenolic hydroxyl, primary and secondary aliphatic hydroxyl groups, ketone and aldehyde groups. Hydroxyl groups are characteristic functional groups of lignin and determine much its reactivity in delignification, condensation, oxidation processes and at the chemical modification of various derivatives. In natural lignin preparations the total hydroxyl group content forms one hydroxyl lignin per a structural unit of phenyl propane on an average. The complexity of the quantitative evaluation of the aliphatic and aromatic hydroxyl group content in lignins is due to the fact that their reactivity varies on a fairly large scale owing to the effect of other functional groups and the spatial position of phenyl propane chains. Lignin and non-cellulose carbohydrates form a common network in the matrix with the aid of valence bonds. Thereby the constitution of each component plays a significant role. In lignin, which is located immediately in timber, also phenol and partially secondary aliphatic OH groups enter into a phosphorylation reaction in the first place. It was established in the process of the examination of the reticular constitution of the matrix that, as a result of the treatment of timber, an increase in the compactness of the network takes place, i.e. an increase in the number of cross-links, this phenomenon being representative of decreasing the expansion of timber material, changing its mechanical properties accordingly. One can draw the conclusion from the experimental data that with an increase in the operating reagent, also the phosphorus content in the lignin exuded increases, this indicating a combined effect of hydroxyl groups with ferric phosphate. The conclusion given is ascertained by spectral analysis. Stemming from the data and results obtained by us, it is safe to presume that the phosphorylation reaction of lignin takes place at the participation of hydroxyl groups, whereby respective ethers are formed. Whereas a lignin macromolecule contains hydroxyl groups of different natures (aliphatic and phenol), the lignin reaction centre blocking method was applied to examine the direction of the mutual effect of ferric phosphate with the hydroxyl groups of lignin. The IK spectrum of lignin displays well an increase in the intensity of the absorption bands in the zone of the valence fluctuation of hydroxyl groups of 3,000-3,600 cm⁻¹ and the lack of absorption bands of 1,660 and 1,715 cm⁻¹, which is responsible for fluctuations in carbonyl groups. It is concluded from these data that all types of hydroxyl groups of lignin participate in the phosphorylation reaction. In the lack of aliphatic hydroxyl groups in lignin, the smallest amount of phosphorus enter into it, which denotes the progression of the phosphorylation reaction mainly at the participation of the aliphatic hydroxyl groups of lignin. As is evident from the amount of phosphates and hydroxyl groups reacted of lignin obtained from the phosphorus content data, the use of acids with a pH below 1 is not recommended, as a result of the emergence of side reactions of the dissociation of ether bonds of the pinoresinol and phenyl coumaran structures of lignin, which are not stable in an acidic environment. As a result of this, it can be said that iron(III) dihydrogen phosphate dihydrate can enter into the walls of timber cells, fix there and simultaneously ensure the formation of a modified crystalline network, condensing it and filling in the gaps between the spaces. As a result of this, the cell walls alter their state and the ferric phosphate is fixed there for a long period of time. Orthophosphate compounds suit well for the modification of timber, whereas they are capable of forming compounds with hydroxyl groups of cellulose and simultaneously associate functional groups in the timber. The source materials for modification can also be ammophos or carbamide as well as other non-organic compounds containing nitrogen or ammonia, which in turn contain the good compound put forward herein in the phosphate composition. By introducing phosphate compounds into timber, the deformation resistance, longevity, fire resistance and solidity of the timber, the ablation resistance of the phosphate composition of the timber increases, water absorption decreases, light resistance, light stability form, the resistance of the timber treated with this material to mould, colouring and timber decaying fungi and other micro-organisms damaging materials containing cellulose forms.

All this is ascertained by dihydrogen phosphate dihydrate tests in the labs of the Tallinn University of Technology, certificates of studies conducted in the Estonian Microbiology Laboratories of the University of Tartu and a hygroscopicity test conducted in Sweden at the SP Technical Research Institute of Sweden (NT Build 504, N-P603649).

Performer of the test: SP Technical Research Institute of Sweden: SP Trätek 060926 LT

The client: HR Invest Finland, The test is sent to: NT Build 504

TABLE 1

| | Humidity (%) | | |
|---|---|---|---|
| | 23° C., | 27° C., | |
| Product | 50% RH | 90% RH | Results |
| Pine | 12.1 | 20.7 | The surface of the |
| | | | specimen has not changed |
| Treated | 14.0 | 26.6 | The surface of the |
| pine | | | specimen has not changed |
| Kerto LVL | 9.6 | 17.4 | The surface of the |
| | | | specimen has not changed |
| Treated | 9.9 | 18.1 | The surface of the |
| Kerto LVL | | | specimen has not changed |

It is evident from the above data that timber treated with Holz Prof does not absorb much humidity in the case of varied humidity, the humidity of the timber is normal, i.e. the treated timber is not hygroscopic.

Mechanical properties tests were conducted also at the Chair of Timber Treatment of the Tallinn University of Technology.

TABLE 2
Resistance and deformability of main timber types (average
indicators for standard specimens at a humidity of 15%)

| | | Temporal resistance kg/cm² | | |
|---|---|---|---|---|
| | Unit | Compres- | | |
| | weight | sion along | Cross- | |
| Type | kg/m³ | fibres | bending | Stretch |
| Birch | 680 | 460 | 917 | 1,280 |
| +Holz Prof | 714 | 490 | 940 | 1,320 |
| Oak | 720 | 535 | 916 | 1,440 |
| +Holz Prof | 742 | 570 | 945 | 1,440 |
| Spruce | 490 | 428 | 747 | 1,295 |
| +Holz Prof | 510 | 460 | 780 | 1,320 |
| Larch | 650 | 553 | 964 | 1,186 |
| +Holz Prof | 680 | 570 | 980 | 1,230 |
| Aspen | 520 | 401 | 817 | 1,330 |
| +Holz Prof | 546 | 430 | 840 | 1,360 |
| Pine | 520 | 439 | 793 | 1,150 |
| +Holz Prof | 560 | 480 | 820 | 1,250 |

In the table it is evident that the mechanical properties of the timber have improved after treatment with the ferric phosphate based composition (i.e the production of Holz Prof), which ascertain the modification of the timber.

Stemming from the ferric phosphate based composition, OÜ Holz Prof has prepared the following types of production.

1.1 Complex fire protection of timber—the product of Holz Prof in accordance with European Directive 2000/147 and 2001/671 possesses the highest protection class of timber constructions against burning B-s1-d0 standards EN 13823 and EN11925-2, certified by the certification bureau ESTCert OÜ, certificate No 261-02/06, Test Report number TM-16/06 on the basis of results from TUV Nord Group; it was also examined in relation to the possibilities of the use of the timber in various climatic conditions on the basis of standards NT 053 and NT054, on the basis of ISO 5660-1 methodology conducted by the SP Technical Research Institute of Sweden, certificate P705121A.

Accelerated testing of timber products impregnated with a fire resistant agent under the influence of weather conditions was conducted in Finland, by an expert commission of company HR-Invest OY. In the case of the specimens NT FIRE 053 methodology, method B was used, which involved accelerated tests under the influence of precipitation, drying cycles, as well as under the influence of UV radiation. Prior to and after the accelerated tests under the influence of weather the specimens were put through a fire test in a cone-shaped calorimeter, pursuant to standard ISO 5660.

Total amount of heat discharged during a fire test in a cone-shaped calorimeter conducted on the basis of standard ISO 5660 (Report SP P705121) prior to and after the influence of weather, according to methodology NT FIRE 053.

TABLE 3

| | Fire | | Total amount of heat discharged | | |
|---|---|---|---|---|---|
| | resistant | | (THR_{1200 c)} MJ/m² | | |
| | impreg- | | Prior | | |
| Type of | nating | | to | After | Change |
| timber | material | Paint coating | modification | | (%) |
| Thermally | HR-Prof | — | 136.6 | 144.4 | 5.7 |
| treated | | | | | |
| birch | | | | | |
| Thermally | HR-Prof | Tung oil | 130.3 | 159.7 | 22.6 |
| treated | | | | | |
| birch | | | | | |
| Cedar | HR-Prof | — | 73.9 | 91.5 | 23.8 |
| Cedar | HR-Prof | Tung oil | 83.7 | 87.8 | 4.9 |
| Larch | HR-Prof | — | 95.1 | 107.3 | 12.8 |
| Larch | HR-Prof | Tung oil | 95.6 | 104.0 | 8.8 |
| Spruce | HR-Prof | — | 91.2 | 100.2 | 9.9 |
| Spruce | HR-Prof | Linseed oil | 103.2 | 107.3 | 4.0 |
| | | 80% and tung | | | |
| | | oil 20% | | | |
| Spruce | HR-Prof | Linseed oil | 110.8 | 91.0 | −17.9 |
| | | 80% and tung | | | |
| | | oil 20% and | | | |
| | | linseed oil | | | |
| | | based precoat | | | |

Pursuant to the data of Table 3, most of the products meet the requirements (the total amount of heat discharged THR_{1200 c} does not exceed 20% in relation to the total value when testing prior to the influence of weather) according to NT FIRE 054 methodology.

Thus all the properties of the timber that are preserved prior to and after testing with UV radiation, rain, ventilation and other weather conditions are ascertained.

The results of these tests ascertain the modification of the timber with the ferric phosphate based composition according to the invention, its fixing in the timber and the achievement of high fire protection and bio-protection properties. The constitution of this composition is as follows: iron(III) dihydrogen phosphate dihydrate—20%, carbamide up to 2%, boric acid up to 2% and non-ionogenic PAV up to 0.2%.

The iron oxide, phosphoric acid and aluminium oxide affect the ratio of CO/CO₂, inhibiting the oxidation of carbon into carbon dioxide, which decreases the exothermic effect of the process substantially. The inorganic phosphate compounds inhibit the burning process of the cellulose. Phosphoric acid starts to dehydrate at 213° C., transferring into pyrophosphoric acid H₄P₂O₇, which slowly transfers at 800° C. into metaphosphoric acid HP₂O₃, thereby the said compounds do not escape at an active incandescence temperature (500-700° C.). With the influence of the composition applied to the cellulose materials, the mechanism of their thermal decomposition cahenges. The modifications of the cellulose in the presence of the iron, phosphorus and aluminium are characterised by the commencement of lower temperature destruction, an increase in the outputs of char and water at a smaller discharge of volatile, including combustible degradation compounds (carbon oxide, levoglucosan, etc.). The antipyretic effect of the ferric phosphate based composition on the timber complex is mainly due to a rapid change in the mechanism of the thermal changes of the carbohydrate part of the timber complex. This catalyses the dehydration reaction of the cellulose. As a result of this, the effective energy of the activation of the dehydration process decreases, the temperature of the commencement thereof decreases, the speed and amount of the discharge of the water formed increase.

When using compounds containing nitrogen and phosphorus with carbamide, a synergic effect is observed at the achievement of the fire protection goals, i.e. the effect of such compositions is higher that that of compositions, in which compounds containing merely phosphorus or nitrogen are used.

The synergy of the nitrogen-phosphorus system is explained by the formation of P—N bonds facilitating the phosphorylation of the thermal decomposition process and intensifying the effect of the antipyrenes as catalysts of the dehydration.

TUV Nord Estonia, Test-report TM 16-16/06, Jun. 19, 2006.

TABLE 4

| | Timber covered with | |
|---|---|---|
| Test parameters | protective coating | Uncovered timber |
| FIGRA 0.2 m, W/s | 51.7 | 440 |
| THR 600 s, MJ | 2.9 | 15.7 |
| SMOGRA m²/s² | 0.5 | 3 |
| TSP 600 s, m² | 41.9 | 47 |

In order to ascertain the advantages of the invention based composition, tests were conducted in relation of the effect of the Holz Prof (HR Prof) composition on fire resistance at the Savonia University of Applied Sciences of Finlandia, pursuant to standard EN ISO 9239-1, in April 2009. The tests showed that the Paint/HR Prof combination worked well. Burning corresponded in the case of this combination to the same class as when treated only with HR-Prof. Latex paint as a surface coating paint did not impede the burning much. The specimens tested burned nearly as well as untreated timber. The surface treated specimens burned 190 mm on an average, still achieving burning class A2/B.

When treating a spruce specimen with a planed surface with the protective composition, the advancement of fire shortened almost three times compared to a specimen untreated with the test substance. The advancement of fire of a piece without the protective substance was more than 400 mm, with HR-Prof less than 100 mm. The advancement of fire of thermally treated pine was 440 mm and 50 mm when treated with the fire protection agent.

As a fire protection agent, HR-Prof efficiently protects timber. HR-Prof as the right combination of a surface protection paint is efficient fire protection on the outer lining of buildings.

1.2 Holz Bio—a timber preservative protecting against rotting, mould, blueing and insects—woodworms and containing iron(III) dihydrogen phosphate dihydrate 5%, carbamide 2%, boric acid 2%, non-ionogenic PAV 0.2%, forming 3 bio-protection layers in the timber, increasing wear resistance and durability, preserving the texture of the timber, not preventing its breathing, stopping commenced and preventing possible bio-damage, being highly efficient against other dry rot fungi and other fungi decaying the timber, certified on the basis of the protection efficiency standard of basidiomycetes decaying timber EN 113:1996 methodology EN 84 with leaching in water during 14 days with 10 changes of the water, conducted in Sweden at the SP Technical Research Institute of Sweden, certificate No. P701747.

A special role in the phosphate composition is played by the nanometals of silver, copper and silicon dioxide, which perform their functions in timber protection—they are bactericidal and antiseptic—the silver and copper and the reinforcement of the upper layer and protection against ablation—the silicon. The main peculiarity of the chemical properties of the nanoparticles of the metals is high reactivity, which is due to an increased proclivity towards an ion and atom exchange, adsorption on varied surfaces, the formation of superficial bonds with other adsorbing particles. The studies were ascertained in a 2005 summary of the Nizhegorodsk State Medical Academy (Russia), where bactericidal and antiseptic qualities of even 2% solution are confirmed.

1.3 The precoat Natur is a primer, which is meant for treating timber prior to painting, protecting against rotting, decaying, mould and timber deconstructing fungi and timber eating insects, having antiseptic and antibacterial properties, disinfecting and protecting mineral bases, concrete, plaster and other building constructions against mould, consisting of 8% iron(III) dihydrogen phosphate dihydrate, 2% carbamide, 2% boric acid, up to 0.1% PAV. Certified on the basis of European standard EN 1276, a study by the Central Laboratory of Microbiology No. 4655 in the field of neutralising such aggressive bacteria as Escherichia coli, Staphylococcus aureus, Enterococcus hirae, Pseudomonas aeruginosa and others, an important role in neutralising these bacteria is played by the phosphate composition, based on the oxides of the nanometals of aluminium, iron, silver and silicon.

It has been verified that both the solutions of the nanoparticles, as well as the materials modified by them, have high biocidal or catalytic properties. To date, the biocidal properties of the nanoparticles of silver have been examined most. Solution of the nanoparticles and materials modified by them were examined—in all cases high antimicrobial activity against a broad spectrum of a wide array of micro-organisms has been discovered.

All materials based on the ferric phosphate based composition require a certain procedure, which involves the cleaning of the treated spot from dirt, dust, bark, phloem, other coatings, then the timber surface is treated with a brush, paint roller, airbrush at an ambient temperature of no less than +5° C., at humidity of no more than 75%, as well as by immersion, soaking or autoclaving. Applying with the brush, paint roller or airbrush is performed with takes, with a break of 20-40 minutes, ensuring standardised total consumption. The soaking or impregnation in the autoclave is performed until reaching standardised consumption. Resistance to ablation forms within 7 days. Total consumption when applying with the brush, paint roller, airbrush—at least 200-300 g/m² (1 litre per 3-5 m²); consumption at the soaking or autoclaving depending on the timber and the treatment quality thereof 40-100 kg/m³.

1.4. HP Anti Rust—protection of metals against rust, stops and converts the rust, develops on the treatable surface of the metal to be protected a strong protective coating layer of metal—aluminium, iron, manganese, etc.—oxides.

The constitution of this material involves iron(III) dihydrogen phosphate dihydrate 20%, orthophosphoric acid 20%, manganese oxide up to 0.1% and PAV.

While containing such substances as orthophosphoric acid, iron, aluminium, manganese, etc., phosphates, the composition material according to the invention combines all properties to fight corrosion, it is a rust converter—removes a decomposed layer of iron by converting it into a protective layer of metal oxides, an inhibitor—a decelerator of corrosion, decelerates and stops the chemical reaction of iron decomposition, while being also a passivating agent—creates a film of soft and plastic aluminium, zinc and other metal oxides, which in aggressive environments undertakes the decomposing impact of corrosion in the first place and decomposes itself with the passage of time, yet protects the main metal from rusting, while being also a reinforcing additive of manganese and silicon on the upper layer, which prevents and protects from mechanical damage.

As a result and stemming from the aforementioned in the study examined, its results ascertain the finding out of the best properties of inorganic ferric phosphates at the modification of timber. This is manifested primarily in the chemical structure of the polysaccharide of cellulose, the hydroxy-group in the phosphonate composition, which at direct phosphorylation and/or the formation of iron-rich phosphonates (according to an nucleophilic mechanism) becomes inhibited from entering into the trophic processes of micro-organisms and blocks them on the one hand, and are substantially less subject to thermal oxidation processes on the other hand, which was ascertained by the results of the practical studies referred to. Timber having been through such a treatment is modified towards protection from microbiological effects by blocking namely the active hydroxy-groups. The chemism of the processes of the obtainment of viscose—a material with high corrosion resistance—is an indirect ascertainment of the mechanism described, where the blocking of hydroxy-groups the practical results of achieving the quality of goods offered manufactured by Holz Prof on the basis of dihydrogen phosphates and the existing results of tests and quality certificates owned by them play their part.

Yet namely the use of iron-rich phosphonates also increases the temperature and corrosion resistance of timber and it does the same also in the case of metal respectively, which places the treatment method offered among the most leading and undoubtedly the most competitive. The claims presented in relation to both the materials, as well as the toxicology of the prototypes and analogues, are clearly irrefutable and convincing.

One can also suggest the use of the said phosphate composition in other directions, such as the creation of sanitary-epidemiological agents of the new generation for use: in rooms for the disinfection of surfaces, items of furniture, sanitary equipment, medical products, laundry, maintenance agents of patients in the case of bacterial, viral, fungal infections; in agricultural rooms (cowsheds, poultry farms, pigsties, greenhouses, etc.); for the disinfection of water and other liquids;
when carrying through overall cleanings in medical-prophylactic and penitentiary institutions, at the facilities of the public utilities board, in public catering companies, sports complexes and other institutions of mass visiting;
the modification of traditional materials for the purposes of rendering them efficient biocidal properties (bandage materials and polymeric products with medical and sanitary-hygienic use; fabrics and textile products; varnishes and paints, other building and timber-chipboard material; paper and cardboard; various types of packaging materials and containers; polymeric materials and plastics; the filters of water supply and air conditioning systems; ceramics and glass; other materials and coating agents) Another characteristic of the invention is that the iron(III) dihydrogen phosphate dihydrate acts as a modifier by entering into a chemical reaction with the cellulose. At the modification the iron(III) dihydrogen phosphate dihydrate fixes to the timber surface and forms a protecting surface cover.
medicine (cancer treatment; infections of nasal, auricular, laryngeal organs; inflammatory infections of the mouth cavity; bronchial-pulmonary diseases; diseases of the gastric-intestinal tract; prophylactics and fighting infection processes, which involve antiseptic lavage, application, water disinfection, food preservation, air filtering, antimicrobial protection of garments, footwear, household items; infectious damage of bones, bone marrow, muscles, joints, lymph nodes. All degrees of burn, purulent non-healing wounds, erysipelas inflammations, fistulas; bacterial, viral or fungal inflammatory processes—conjunctivitis, blepharitis, keratitis, inflammation of the middle ear, pharyngitis, laryngitis, tracheitis, tonsillitis, rhinitis, sinusitises, ORVI, vaginitis, erosion of the cervix, polyposis, myoma, fibroma, cystic formations, dermatitises, dermatoses, eczemas, furunculosis, acne, pimples, fungal damage, stomatitis, gingivitis, periodontosis, periodontitis, pulpitis, basaliomas, skin cancer, rash with acne and abscesses, the restoration of the acid-base balance of the skin, etc.);
the cosmetics, perfumery industry (the manufacturing of shampoos, creams, toothpastes, washing powders, varnishes, paints, fabrics, hygiene instruments, etc., with new consumption properties).

Special attention must be paid to the novelty of the theoretical approach. No earlier observations were encountered in literature regarding the described method as nucleophilic phosphorylation.

1. An ferric phosphate based composition obtained at mixing 100 mass fractions of orthophosphoric acid, iron(III) oxide, aluminium and water, wherein that as an aluminium source, powdery aluminium oxide in the amount of 5-10 mass fractions is used, the amount of the iron oxide does not exceed 20 mass fractions, preferably being within a range of 10-20 mass fractions, and the amount of the water constitutes 100 mass fractions, whereas at least one nanopowder from among silver, copper or flint is added to the mixture in the amount of 0.5 mass fractions.

2. The composition pursuant to claim 1, wherein that the reaction takes place within a temperature range of 60-70° C. and it is controlled by the amounts of the aluminium oxide and nanopowders added. As a result of the synthesis, a colloidal solution of the orthophosphates is obtained from the nano-iron, -aluminium and silver, copper, silicon metals, which comprise a composition of iron aluminium phosphate Fe(H2PO4)3 and Al(H2PO4)3 with the particle sizes of the metals from 50 to 100 run.

3. The composition pursuant to claim 1, wherein that 85% orthophosphoric acid is used.

4. The composition pursuant to claim 1, wherein that the sizes of the particles of the nanopowders are 50-100 nanometre.

5. The composition pursuant to claim 1, wherein that the main component is iron(III) dihydrogen phosphate dihydrate.

6. The composition pursuant to claim 1, wherein the composition is used as a fire protective agent of timber and other materials containing cellulose.

7. The composition according to claim wherein the composition is used for the bio-protection of timber against decay and rotting.

8. The composition according to claim 1, wherein the composition is used as a disinfecting antibacterial agent.

9. The composition according to claim 1, wherein the composition is used as a rust converter protecting agent against the corrosion of metals.

10. The composition according to claim wherein the composition is used as a modifier by entering into a chemical reaction with the cellulose.
